(19) United States
(12) Patent Application Publication
(10) Pub. No.: US 2014/0330811 A1
(43) Pub. Date: Nov. 6, 2014

(54) RETRIEVING INFORMATION USING A GRAPHICAL QUERY

(71) Applicant: International Business Machines Corporation, Armonk, NY (US)

(72) Inventors: Pavan V. Ananth, Bangalore (IN); Sreenivasulu Valmeti, Nellore (IN)

(73) Assignee: International Business Machines Corporation, Armonk, NY (US)

(21) Appl. No.: 13/893,402

(22) Filed: May 14, 2013

Related U.S. Application Data
(63) Continuation of application No. 13/886,384, filed on May 3, 2013.

(51) Int. Cl. G06F 17/30

(52) U.S. Cl. CPC G06F 17/30554
USPC 707/722

(57) ABSTRACT

Embodiments of the present invention disclose a method, computer program product, and system. In an embodiment, a computing device receives a connection between a first object and a second object, wherein the connection represents a query. The computing device, responsive to receiving the connection, executes the query of the connection and obtains a result, and displays the result between the first object and the second object on the computing device.

This application is a continuation of U.S. patent application Ser. No. 13/886,384 filed May 3, 2013 the entire content and disclosure of which is incorporated herein by reference.

### FIELD OF THE INVENTION

The present disclosure relates generally to the field of information retrieval, and more particularly to retrieving information using a graphical query of a class diagram.

### BACKGROUND OF THE INVENTION

System designers use models of the final system to negotiate the system design, ensure all resulting requirements, and rule out unintended behavior manifesting itself during the system's lifetime. Models are used by software engineers to model the intensional structure of a system in terms of classes, attributes and operations, and to express constraints that must hold for every instance of the system. A model contains model objects, such as actors, use cases, classes, and packages, and one or more diagrams that show a specific perspective of a system. Class diagrams are class-based formalisms used for conceptual modeling. Reasoning over class diagrams is of paramount importance in design, validation, maintenance, and system analysis, however, for medium and large software projects, reasoning over class diagrams may be impractical. Query answering, in particular, can be used to verify, for example, whether a (possibly incomplete) instance of the system modeled by the class diagram, i.e., a snapshot, enjoys a certain property.

### SUMMARY

Embodiments of the present invention disclose a method, computer program product, and system. In an embodiment, a computing device receives a connection between a first object and a second object, wherein the connection represents a query. The computing device, responsive to receiving the connection, executes the query of the connection and obtains a result, and displays the result between the first object and the second object on the computing device.

### BRIEF DESCRIPTION OF THE SEVERAL VIEWS OF THE DRAWINGS

FIG. 1 is a block diagram illustrating an environment, in accordance with an embodiment of the present invention.

FIG. 2 depicts an exemplary illustration of class relationships and a binary query result, in accordance with an embodiment of the present invention.

FIG. 3 depicts the operational steps of a program function executing on an application server, in accordance with an embodiment of the present invention.

FIG. 4 depicts a block diagram of components of the application server executing the program function, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

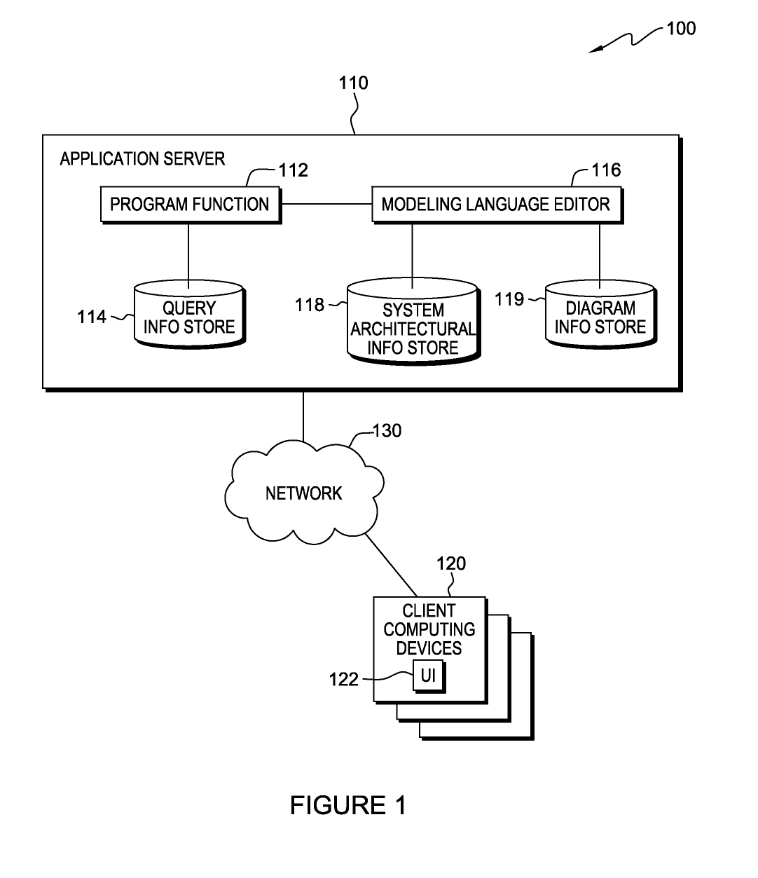

The present disclosure will now be described in detail with reference to the Figures. FIG. 1 is a block diagram illustrating an environment, generally designated 100, in accordance with one embodiment of the present invention.

Environment 100 includes client computing devices 120 and application server 110, all interconnected over network 130. Network 130 can be, for example, a local area network (LAN), a wide area network (WAN) such as the Internet, or a combination of the two, and can include wired, wireless, fiber optic connections or a combination thereof. In general, network 130 can be any combination of connections and protocols that will support communications between client computing devices 120 and application server 110.

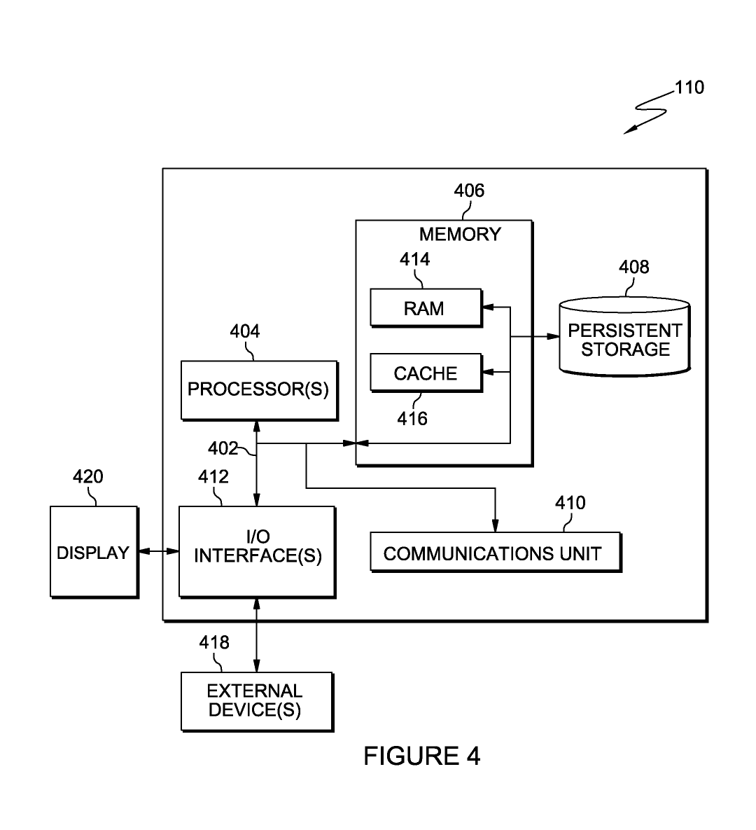

In various embodiments of the present invention, client computing devices 120 and application server 110 may be a laptop computer, tablet computer, netbook computer, personal computer (PC), a desktop computer, a personal digital assistant (PDA), a smart phone, or any programmable electronic device as described in further detail with respect to FIG. 4. Client computing devices 120 are in communication with application server 110 via network 130. Client computing devices 120 represent computing devices that are used by a user to access, via network 130, and manipulate modeling language editor 116, in accordance with an embodiment of the present invention. Client computing devices 120 include user interfaces 122, which a user of a computing device included in client computing devices 120 uses to access and manipulate modeling language editor 116, in accordance with an embodiment of the present invention. Client computing devices 120 can receive binary query results for display.

Application server 110 is in communication with client computing devices 120 via network 130. Application server 110 represents a computing device that provides a modeling language editor application to computing devices within environment 100, for example, client computing devices 120, in accordance with an embodiment of the present invention. Application server 110 includes modeling language editor 116 and program function 112. Application server 110 can, via network 130, transmit information to client computing devices 120 for display. Application server 110 provides modeling language applications to computing devices within environment 100, in accordance with an embodiment of the present invention.

In an embodiment, modeling language editor 116 is in communication with system architectural information store 118, diagram information store 119, and program function 112. Modeling language editor 116 represents software that models system architectural information, in accordance with an embodiment of the present invention.

System architectural information store 118 is an information repository that includes system architectural information utilized by modeling language editor 116 to generate a class diagram and/or execute a query, for example, a binary query.

In one embodiment, diagram information store 119 is an information repository that includes class diagrams generated by modeling language editor 116 utilizing system architectural information included in system architectural information store 118. In another embodiment, diagram information store 119 also includes class diagrams not generated by modeling language editor 116. Modeling language editor 116 generates a class diagram utilizing system architectural information included in system architectural information store 118. In an embodiment, modeling language editor 116 can also utilize system architectural information not included in system architectural information store 118.

Modeling language editor 116 utilizes system architectural information to generate a visualization of a system's architectural blueprint. For example, system architectural information utilized by modeling language editor 116 is information related to an activity, actor, business process, database schema, logical component, programming language statement, and/or reusable software component. In an embodiment, a class diagram generated by modeling language editor 116 reflects the classes of the system architectural information of interest, the associations among them, as well as their attributes and operations. In another embodiment, modeling language editor 116 generates a class diagram using a modeling language, such as the Unified Modeling Language.

The Unified Modeling Language (hereinafter “UML”) is a standardized general-purpose modeling language in the field of object-oriented software engineering. UML includes a set of graphic notation techniques to create visual models of object-oriented software-intensive systems. UML is used to specify, visualize, modify, construct and document the artifacts of an object-oriented software-intensive system under development. UML is utilized to visualize a system's architectural blueprints, including activities, actors, business processes, database schemas, programming language statements, and reusable software components.

Models, such as UML models, represent a system or application that contain model objects, such as actors, use cases, classes, and packages, and one or more diagrams that show a specific perspective of a system. A diagram is a graphic representation of a system's model. Class diagrams emphasize the dynamic behavior of a system by showing collaborations among objects and changes to the internal states of objects. Objects can be tangible things that have some meaning, role, and purpose in the system.

In an embodiment, class diagrams generated by modeling language editor 116 describe the structure of a system by showing the system's classes, their attributes, operations, and the relationships among the classes. In another embodiment, modeling language editor 116 displays class diagrams with boxes that reflect the name, attributes, and methods or operations of the class. In yet another embodiment, modeling language editor 116 generates class diagrams that depict at least one class relationship that reflects a logical connection between two classes included in the generated class diagram, for example, an association, aggregation, composition, generalization, realization, and dependency.

Modeling language editor 116 can execute a query, for example, a binary query, utilizing information included in system architectural information store 118 and/or diagram information store 119. Modeling language editor 116 can receive and execute instructions from program function 112, such as instructions to execute a binary query. Binary queries are queries that have one of two possible results and also include Boolean queries, which are queries that have results characterized by either true or false. Modeling language editor 116 can, via application server 110, transmit query results and/or class diagrams to client computing devices 120 for viewing. In general, modeling language editor 116 can be any modeling language editor that can execute a binary query on a class diagram that depicts at least one class relationship, in accordance with an embodiment of the present invention.

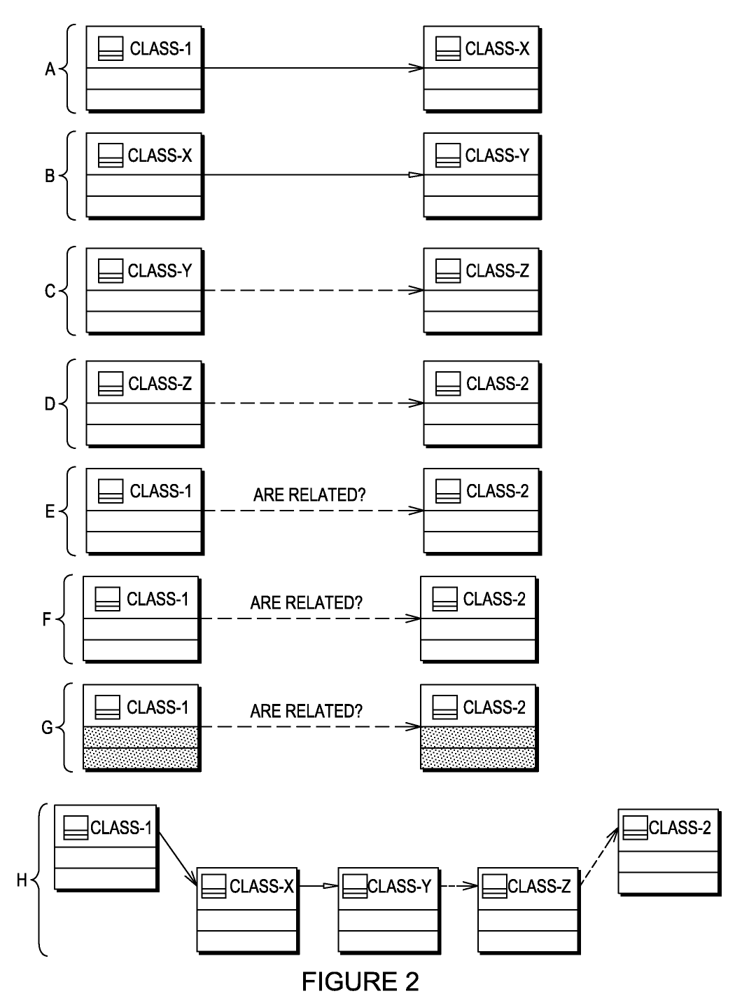

In an embodiment, program function 112 is in communication with query information store 114 and modeling language editor 116. Program function 112 represents software that generates a visual depiction of a binary query result generated by a modeling language editor, in accordance with an embodiment of the present invention. Query information store 114 is an information repository that includes information related to binary query results generated by modeling language editor 116. In an embodiment, such information includes binary query results generated by modeling language editor 116 utilizing information included in system architectural information store 118 and/or diagram information store 119. In another embodiment, query information store 114 includes a binary query repository that includes predetermined binary query connectors that can be executed by modeling language editor 116, such as an “Are related?” binary query connector, which instructs modeling language editor 116 to determine whether two classes included in a class diagram included in diagram information store 119 are related. In yet another embodiment, program function 112 can generate a visual query indicator of a binary query result generated by a modeling language editor, such as modeling language editor 116, as discussed in FIG. 2 below.

In an embodiment, program function 112 generates a visual query indicator for each binary query result type (hereinafter “result type”), for example, a first and second visual query indicator to reflect a first and second result type, respectively. In another embodiment, a visual query indicator includes a connector that connects objects involved in the binary query, as depicted in illustrations F and G of FIG. 2. In yet another embodiment, program function 112 can instruct modeling language editor 116 to execute binary queries using information included in system architectural information store 118 and/or diagram information store 119. Program function 112 instructs modeling language editor 116 to execute a query when program function 112 receives a connection of a displayed first object and a displayed second object, wherein the connection is displayed as a connector, and wherein the connector represents a query. In other embodiments, the connection represents a query. An embodiment of the present invention will now be discussed in relationship to FIG. 2.

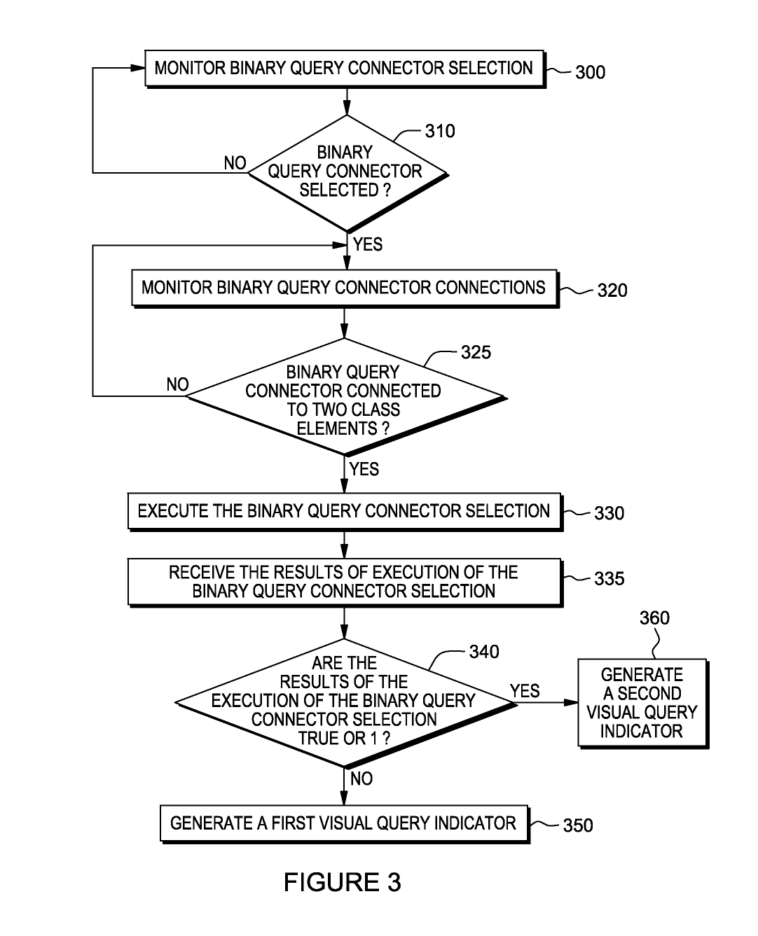

Concepts introduced in the following discussion of FIG. 2 will be used further in the discussion of FIG. 3. FIG. 2 depicts exemplary illustrations of class relationships and an associated binary query result, in accordance with an embodiment of the present invention. Illustrations A through D depict class relationships that exist between classes Class-1, Class-X, Class-Y, Class-Z, and Class2 included in class diagram XYZ, which is included in diagram information store 119. In particular, illustration A reflects that Class-1 is associated with Class-X via a modeling language association relationship icon that is a solid line and extends from Class-1 to Class-X and has an arrow on the associated end of the icon. In an embodiment, modeling language editor 116 generates class diagrams that include subclasses, which are specific classes, and/or superclasses, which are general classes.

Illustration B shows that Class-X inherits from Class-Y via a modeling language inheritance relationship icon that is a solid line and extends from Class-X to Class-Y and has a hollow triangle shape on the superclass end of the icon. Illustration C shows that Class-Y is dependent on Class-Z via a modeling language dependency relationship icon that is a dashed line and extends from Class-Y to Class-Z and has an arrow on the dependency end of the icon. In the same vein, illustration D reflects that Class-Z is dependent on Class-2 via the modeling language dependency icon that is a dashed line that extends from Class-Z to Class-2 and has an arrow on the dependency end of the icon.

Illustration E depicts a binary query connector connecting two objects. The user, via user interface 122, accesses query information store 114 and selects the “Are Related?” binary query connector. Subsequently, the user connects Class-1 and Class-2 with the “Are Related?” binary query connector by, for example, clicking on Class-1 with a pointing device of user interface 122, and dragging a visual connection indicator to Class-2 with the pointing device. In response to the user connecting Class-1 and Class-2 with the selected binary query connector, as reflected in illustration E, program function 112 instructs modeling language editor 116 to execute the binary query of the binary query connector.

Modeling language editor 116 executes the binary query and sends the results to program function 112. In response to receiving the binary query results, which are the result of the executing of the binary query connector selection, from modeling language editor 116, program function 112 determines whether the results are true or 1 and generates a visual query indicator of the received binary query result. For example, a visual query indicator generated by program function 112 can be textual, graphical, and/or audible in nature. In an embodiment, a visual query indicator generated by program function 112 can be displayed with one or more of a first class, second class, and binary query connector. In an embodiment, the visual query indicator includes the selected binary query connector and/or the participant objects. In another embodiment, if the received binary query results are true or 1, then program function 112 generates a first visual indicator of the received binary query results, as reflected in the un-shaded regions of classes of illustration F. In yet another embodiment, if the received binary query results are false or 0, then program function 112 generates a second visual indicator of the received binary query results, as reflected in the partially shaded regions of classes of illustration G.

In yet another embodiment, program function 112 generates a third visual indicator that includes a graphical depiction of the binary query results. For example, illustration H illustrates a third visual indicator, which is a visual depiction of the received binary query results generated by program function 112 that reflects the details of the “Are Related?” binary query executed by modeling language editor 116, in accordance with an embodiment of the present invention. In particular, illustration H depicts that Class-1 is related Class-2 by Class-1′ relationship to Class-X, which is related to Class-Y, which is related to Class-Z, which is ultimately related to Class-2.

FIG. 3 depicts the operational steps of program function 112 executing on application server 110, in accordance with an embodiment of the present invention. Program function 112 monitors binary query connector selections (step 300). If program function 112 determines that a binary query connector was not selected, then return to step 300 (“no” branch of decisional 310), else program function 112 proceeds to step 320 (“yes” branch of decisional 310). Program function 112 monitors binary query connector connections (step 320). If program function 112 determines that binary query connector is not connected to two class objects (“no” branch of decisional 325), then program function 112 returns to step 320, else program function 112 proceeds to step 330 (“yes” branch of decisional 325).

Program function 112 instructs modeling language editor 116 to execute the binary query connector selection (step 330). Subsequently, program function 112 receives the results of the executing of the binary query connector selection (step 335). If program function 112 determines that the results of the executing of the binary query connector selection are not true or equal to 1 (“no” branch of decisional 340), then program function 112 generates a first visual query indicator (step 350). If program function 112 determines that the results of the executing of the binary query connector selection are true or equal to 1 (“yes” branch of decisional 340), then program function 112 generates a second visual query indicator (step 360).

FIG. 4 depicts a block diagram of components of application server 110 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Application server 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Program function 112, modeling language editor 116, query information store 114, system architectural information store 118, and diagram information store 119 are stored in persistent storage 408 for execution by and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including client computing devices 120. In these examples, communications unit 410 includes one or more network interface cards. Communications unit 410 may provide communications through the use of either or both physical and wireless communications links. Program function 112 and modeling language editor 116 may be downloaded to persistent storage 408 through communications unit 410.

I/O interface(s) 412 allows for input and output of data with other devices that may be connected to server computer 102. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., program function 112, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for retrieving information using a graphical query of a class diagram, the method comprising:
receiving, using a computing device, a connection between a first object and a second object, wherein the connection represents a query;
responsive to receiving the connection, executing the query of the connection and obtaining a result; and
displaying the result between the first object and the second object on the computing device.

2. The method of claim 1, wherein the query is a binary query.

3. The method of claim 1, wherein the first and second objects includes one or more of the following relationships: association, aggregation, composition, generalization, realization, dependency.

4. The method of claim 1, wherein the connection is a connector, and wherein the connector represents a query.

5. The method of claim 4, wherein the executing of the query of the connection occurs responsive to the connector connecting the first and second objects.

6. The method of claim 1, wherein the first and second objects are part of a class diagram generated by utilizing a modeling language.
